(19) United States
(12) Patent Application Publication
(10) Pub. No.: US 2018/0213340 A1
(43) Pub. Date: Jul. 26, 2018

(54) HIGH THROUGHPUT ACOUSTIC VENT STRUCTURE TEST APPARATUS

(71) Applicant: W. L. Gore & Associates, Inc., Newark, DE (US)

(72) Inventors: Dustin Perrin, Newark, DE (US); Ryan Kenaley, Hockessin, DE (US); John Murray, Shenzhen (CN); Chad Banter, Lincoln University, PA (US)

(21) Appl. No.: 15/416,623

(22) Filed: Jan. 26, 2017

(51) Int. Cl. H04R 29/00

(52) U.S. Cl. CPC H04R 29/004; G10K 11/172

(57) ABSTRACT

A high throughput acoustic vent structure test apparatus includes first and second elements that can removably connect with one another to sealingly enclose an acoustic cavity. A test sample holder can be enclosed in the acoustic cavity, the test sample holder having a test sample side and a microphone side, with a plurality of ports therethrough and a plurality of microphones on the microphone side connected with the ports. An acoustic source is positioned in the acoustic cavity opposite the test sample holder, and operable to generate an acoustic signal that can be picked up by the microphones through the plurality of ports. In operation, test samples of acoustic vent structures can be positioned on the test sample holder.

### TECHNICAL FIELD

The present invention relates to high throughput test apparatus for acoustic vent structures such as, but not limited to, protective covers and membranes.

### BACKGROUND

Electronic devices such as cellular phones, pagers, radios, hearing aids, headsets, barcode scanners, digital cameras, etc. are designed with enclosures having small openings located over an acoustic transducer (such as a bell, speaker, microphone, buzzer, loudspeaker, etc.) to allow sound transmission. Protective acoustic vent structures such as acoustic covers are placed over openings to protect the transducer from damage from dust and water intrusion.

Known protective acoustic covers include non-porous films and micro-porous membranes, such as expanded PTFE (ePTFE). Protective acoustic covers are also described in U.S. Pat. No. 6,512,834 and U.S. Pat. No. 5,828,012.

Membranes for acoustic protective covers must be capable of protecting an enclosure from intrusion, e.g., from foreign contaminants like water or dust, while also adequately conveying sound. While test protocols exist for many facets of acoustic vent structure testing, there exists a need for improved apparatuses and methods to conduct high throughput testing on acoustic vent structures across a range of frequencies, especially at high frequencies.

Some test apparatuses for acoustic devices are disclosed in the following references. For example, U.S. Patent Pub. No. 2008/304674 discloses a hearing device test adapter that connects a hearing device to a test microphone. Similarly, U.S. Pat. No. 8,194,870 discloses a system and method for open fitting hearing aid frequency response sound measurements; U.S. Pat. No. 4,038,500 discloses a microphone coupler for use in performing frequency response tests on earphones; U.S. Pat. No. 3,876,035 discloses a testing apparatus for hearing aids and the like; and U.S. Pat. No. 2,530,383 discloses microphones, e.g., by way of an acoustic coupler that couples the microphone to be tested to a source of acoustic energy. However, the aforementioned publications do not describe apparatuses or methods for conducting high throughput testing on acoustic vent structures.

### BRIEF SUMMARY

According to some embodiments, the present disclosure provides a testing apparatus for high throughput quality control testing for acoustic vent structures, e.g., for testing protective acoustic covers or microphone covers, membranes, and the like. In one embodiment, the vent structure comprises at least one membrane. Some embodiments include a near field testing apparatus for measuring acoustic insertion loss of acoustic vent structures including a first element and second element. In some embodiments, an acoustic phase may be measured instead of or in addition to acoustic insertion loss. The second element is removably connectible to the first element, and the first and second elements define at least one closed acoustic chamber when the first and second elements are connected. The first element has at least one acoustic cavity, one or more first alignment features, and at least one sound source capable of generating sound within each of the at least one acoustic cavities. The second element has one or more second alignment features arranged to connect with the one or more first alignment features, a plurality of microphones configured to detect acoustic signals, a plurality of ports that each define an acoustic channel between one of the at least one closed acoustic chamber and one of the plurality of microphones, and one or more sample holders for a plurality of acoustic vent structures to be positioned over at least one of the plurality of microphones. Each cavity of the at least one acoustic cavity is aligned with a respective port of the plurality of ports when the second element is connected with the first element.

According to some embodiments, the sound source is capable of generating sound within each of the at least one acoustic cavities through some or all of the range of 10 Hz to 30 kHz, e.g., in the range of 10 Hz to 20 kHz, in the range of 20 Hz to 20 kHz, in the range of 100 Hz to 20 kHz, or in the range of 100 Hz to 10 kHz. In one embodiment, the testing apparatus is particular useful for testing higher frequencies over 10 kHz that tend to be more difficult to measure. The plurality of sample holders can include at least one plate containing the plurality of ports therethrough, wherein the plurality of microphones is positioned on a first side of the plate opposite the closed acoustic chamber; and a second side of the plate facing the closed acoustic chamber is configured to receive the plurality of acoustic vent structures. According to some embodiments, the at least one plate is removable from the second element (i.e. for removing or replacing microphones from the sample holder). According to some embodiments, each microphone of the plurality of microphones is a MEMS (Micro-Electrical-Mechanical Systems) microphone. The plurality of MEMS microphones may be arranged in a planar array to measure acoustic insertion loss or acoustic phase, and may also include one or more reference microphones. Reference microphones may also be MEMS microphones.

According to some embodiments, the acoustic cavity is at least partially filled with a passive damping material. The passive damping material may be selected from a group comprising foamed synthetic resins, felts, non-woven fabrics, synthetic resin fibers, and mineral fibers. In some specific embodiments, the passive damping material is fibrillated foam.

According to some embodiments the second element can be repeatably aligned with the first element within a tolerance of 0.1 mm. A backing cavity can be arranged on a side of the sample holder opposite to the at least one closed acoustic cavity, the backing cavity including an acoustic dampening material.

### BRIEF DESCRIPTION OF THE DRAWINGS

The present disclosure will be better understood in view of the appended non-limiting figures.

FIG. 1 shows an example of a high throughput acoustic test apparatus in a side section view and in an open position, in accordance with some embodiments;

FIG. 2 shows the high throughput acoustic test apparatus of FIG. 1 in a closed position;

FIG. 3 shows an example of a first sample holder for holding multiple acoustic cover test samples in a perspective view, and showing a microphone side of the example holder, in accordance with some embodiments;

FIG. 4 shows the first sample holder of FIG. 3 in a perspective view showing a sample side of the example holder;

FIG. 5 shows an example of an acoustic cover test sample being positioned on a sample side of an example sample holder similar to the example holder of FIGS. 3 and 4, in accordance with some embodiments;

FIG. 6 shows an example of an alternative acoustic cover test sample being positioned on an alternative embodiment of an example sample holder, in accordance with some embodiments;

FIG. 7 shows an example of a second high throughput acoustic test apparatus having acoustic chambers, in a side section view and in a closed position, in accordance with embodiments;

FIG. 8 shows an example system for performing high throughput testing of acoustic vent structures using an apparatus similar to the acoustic test apparatuses shown in FIGS. 1, 2, and 7;

FIG. 9 illustrates an example process for utilizing a testing apparatus as shown in FIG. 1, 7 or 8; and

FIG. 10 shows a graphical representation illustrating acoustic loss variability between acoustic ports in a testing apparatus similar to the apparatuses shown in FIGS. 1, 7, and 8.

While the following is amenable to various modifications and alternative forms, specific embodiments have been shown by way of example in the drawings and are described in detail below. The intention, however, is not to limit the claims to the particular embodiments described. On the contrary, the description is intended to cover all modifications, equivalents, and alternatives thereof.

### DETAILED DESCRIPTION

Various embodiments described herein address a testing apparatus and methods for high throughput testing for acoustic vent structures, such as but not limited to membranes used in acoustic protective covers or related applications. A high throughput testing apparatus for acoustic vent structures has capacity to subject test samples of acoustic vent structures to an acoustic signal across a range of frequencies and/or across a range of amplitudes, and detect an insertion loss across the test samples in a short period of time. Detecting the insertion loss involves detecting the test acoustic signal that is passed through the acoustic vent structures. The test acoustic signal can be processed, e.g., by a computer, to compare the test acoustic signal to a predetermined baseline acoustic signal to detect, and/or quantify an insertion loss, i.e. a loss in acoustic pressure or sound pressure level (SPL loss), or in some embodiments to detect a change in acoustic phase.

The apparatuses and systems disclosed herein may be used to test a wide range of acoustic parameters of acoustic vent structures and protective layers. For example, some additional acoustic quality metrics that can be measured include but are not limited to: total distortion, total harmonic distortion, intermodulated distortion, difference frequency distortion, acoustic rub, acoustic buzz, perceptual acoustic rub, perceptual acoustic buzz, or signal to noise ratio. Total distortion can be characterized by a power sum of all selected or evaluated harmonics. Total harmonic distortion (THD) can be characterizes as an amount, e.g. by way of a percentage or by way of a dB value, effected by harmonically related distortion for a given fundamental excitation signal, and in some cases can include only harmonics below the 10th harmonic. A value of total harmonic distortion plus noise (THD+noise) can be characterized as the total harmonic distortion with the added inclusion of one or more non-harmonically relates signals. Rub and buzz can be characterized in the same manner as total harmonic distortion, e.g. as a percentage or a dB value, effected by harmonically related distortion for a given fundamental excitation signal that includes only harmonics greater than a floor value, typically the 10th harmonic and also typically less than the 35th.

Analysis of acoustic signals obtained by the methods herein disclosed can be performed by way of a variety of acoustic analysis algorithms. For example, a Fourier-transform based analysis algorithm, like a fast Fourier transform (FFT) algorithm, can be used to assess a typical signal channel response spectrum to monitor background or baseline sound pressure in a microphone. Transfer functions may be applied to perform frequency response analysis for acoustic signal magnitude, phase, distortion, coherence, and related parameters. A real-time analysis algorithm can allow for frequency response analysis while also providing octave and band analysis capability. In one particular example, the FFT-based HARMONICTRAK algorithm (Listen, Inc.) can be used to obtain similar analytical results as a transfer function algorithm based on a sweep stimulus frequency or similar excitation.

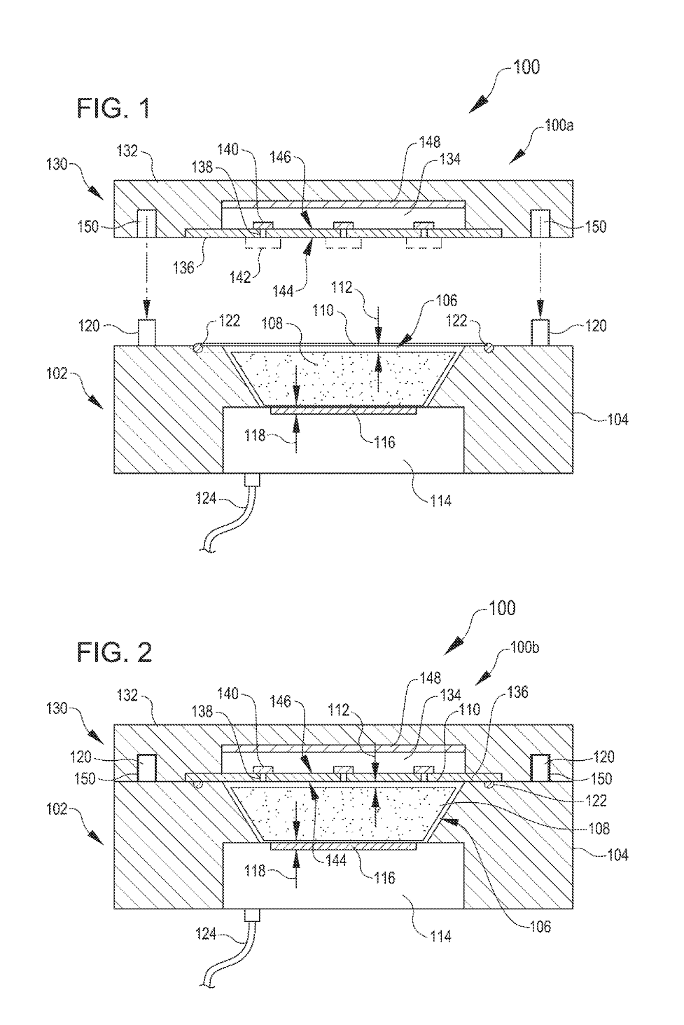

FIG. 1 shows a high throughput acoustic test apparatus 100 in a side section view and in an open position 100a, in accordance with some embodiments. The test apparatus 100 includes a first element 102 and a second element 130 which are configured to be assembled together when the apparatus is in use. In one embodiment, the first element 102 may be a base plate and the second plate may be a test plate. The test apparatus 100 can be repeatedly disassembled to insert or remove acoustic test samples (not shown), and assembled between testing acoustic test samples. This allows the first element 102 and second element 130 to be removably connectible.

The first element 102 includes a first substrate 104 that defines an acoustic cavity 106, the acoustic cavity 106 being defined by a void 110 in the first element 102. The first substrate 104 may be any suitable structural material, such as a plastic or metal, and preferably a material that impedes propagation of sound. The first element 102 also includes alignment features 120, such as posts, pins, holes, or other suitable features which enable the first element 102 to be repeatably aligned with the second element 130.

The acoustic cavity 106 is positioned adjacent to an acoustic source 114, which may be any suitable device for generating acoustic energy toward the acoustic cavity 106. Preferably, the acoustic source 114 comprises a speaker or other suitable audio transducer 116 which is capable of generating directional sound. The acoustic source 114 is capable of directing acoustic energy into the acoustic cavity 106, e.g., by having a transducer 116 oriented toward the acoustic cavity. It will be understood that non-directional sound sources, or sound sources that direct acoustic energy over distance may be used instead provided that they produce a repeatable acoustic signal in the acoustic cavity 106.

For purposes of testing, the source is able to generate repeatability between testing within 1 dB over the frequency range of 10 Hz to 30 kHz, e.g., over the frequency range of 10 Hz to 20 kHz. Source characteristics should be such that pressure equalization within 1 dB can be achieved over the same frequency range. The source is driven at a sound pressure level such that signal/noise ratio is 20 dB or greater.

The first element 102 may also include sealing features 122, such as an O-ring or other comparable sealing member, disposed between the first element 102 and the second element 130 for sealing the acoustic cavity 106 against the second element 130 to create an acoustic chamber. In alternative embodiments, the first and second elements 102, 130 may seal together tightly without further sealing features.

According to some embodiments, the acoustic cavity 106 may also contain a passive damping material 108. The passive damping material can substantially fill the void 110 defining the acoustic cavity 106, i.e., providing an acoustic source clearance 118 to allow acoustic waves to propagate from the acoustic source 114 and test sample clearance 112 to allow acoustic waves to propagate through any test samples. Preferably, the acoustic source clearance 118 is on the order of 2 mm, or within a range of 0.1 to 10 mm. The test sample clearance 112 may be approximately 0.5 mm, but may include ranges from 0.1 to 3 mm. The passive damping material 108 can be selected from a group consisting of foamed synthetic resins, felts, non-woven fabrics, synthetic resin fibers and mineral fibers. In some specific embodiments, the passive damping material 108 is fibrillated foam, e.g., fibrillated foam of polypropylene. The size of the acoustic cavity 106 is proportioned for operating in a near-field mode. For example, the acoustic cavity 106 can have a total depth between the acoustic source 114 and the sample holder 136 from about one wavelength of the lowest frequency-tested distance (i.e. distance at the shortest wavelength) when the first and second elements are assembled. By way of example, suitable frequencies for use can include from 10 Hz to 30 kHz, e.g., from 10 Hz to 20 kHz. Sound in air at the highest frequencies has a wavelength of less than 17 mm, which varies depending on the presence or specific material of passive dampening material 108. The acoustic source 114 can include electrical connections 124 to a signal conditioner (not shown) or other suitable signal source for supplying an amplified acoustic signal.

According to some embodiments, the second element 130 comprises a second substrate 132 that is arranged to repeatably mate with the first element 102, and which can retain a sample holder 136 that is arrange to cover the void 110 to fully enclose the acoustic cavity 106. In some embodiments, the sample holder 136 may be arranged so that a test sample side 144 of the sample holder 136 lays flush across a portion of the first element 102 to enclose the acoustic cavity 106. The sample holder 136 may also, or instead, press into the sealing features 122 to seal the acoustic cavity 106. The second substrate 132 can include second alignment features 150 which can interact with the first alignment features 120 for aligning the first and second elements 102, 130 when they are connected together. In some embodiments, the first and second elements 102, 130 can be aligned to within a tolerance of 0.1 mm or less.

The second element 130 further includes a backing cavity 134 adjacent to a portion of the sample holder 136. In particular, the backing cavity 134 is arranged to accommodate one or more microphones 140 on a microphone side 146 of the sample holder 136. As stated herein, the microphones 140 may be arranged in a planar array for repeatability in testing and loading of samples. The microphone side 146 is opposite the test sample side 144 and facing away from the acoustic cavity 106 when the first and second elements 102, 130 are assembled. The backing cavity 134 is sufficiently deep to accommodate the one or more microphones 140, and can open to a conduit (not shown) for accommodating control and power cords for the one or more microphones 140. The backing cavity 134 contains a backing material 148 which can include any suitable acoustic absorptive material, such as a rubber or polymer foam including, e.g., polyurethane foam or similar sound-absorbing material. Both the acoustic source 114 and microphones 140 are enclosed in structures with noise rejection properties such that internal audible noise is 10 dB less than external audible noise averaged across the test frequency range.

Although the sample holder 136 is generally fixed to the second element 130, and is arranged to engage with and separate from the first element 102 when the second element is affixed with or removed from the first element; the sample holder 136 may also be removable from the second element 130. For example, the sample holder 136 may be sized and/or shaped to align with one or more features of the second substrate 132, e.g., with backing cavity 134, and may be removably attached with the second element 130 by such connectors as screws, bolts, pins, clips, or comparable connectors. The sample holder 136 can be removed, e.g., in order to replace one or more of the microphones 140.

The sample holder 136 is arranged to attach with the second element 130 so that the sample holder is repeatably placed in alignment with the acoustic cavity 106 when the second element 130 is assembled with the first element 102. The sample holder 136 includes multiple ports 138 defining through-holes in the sample holder 136. The ports 138 can be on the order of 1 mm in diameter, but can range from 0.2 to 3.0 mm in diameter. The ports 138 are connected at one side of the sample holder 136 with the test sample side 144, and are connected with the one or more microphones 140 at the microphone side 146, so that sound passing through each one of the ports 138 is picked up predominantly by a respective one of the one or more microphones 140. In various embodiments, the sample holder 136 comprises a substantially flat test sample surface 144 which is capable of both sealing to the first element 102 (i.e. by way of sealing features 122), and which is capable of retaining adhered or otherwise affixed test samples thereon.

Each of the ports 138 is associated with a test sample position 142 of the sample holder 136. In some embodiments, the test sample face 144 of the sample holder 136 can be a smooth polymer surface or polymer-coated surface, e.g., a polyimide coated surface, or other comparable coating. Preferably, the test sample face 144 is smooth and capable of adhering to and fully releasing from an adhesive test sample. In some alternative embodiments, the test sample face 144 can be formed of a smooth polymer or polymer coated layer applied and affixed to a structural part of the sample holder 136. The sample holder 136 can be substantially formed of any suitable structural material such as a rigid polymer or metal. The ports 138 are formed through an entire thickness of the sample holder 136, connecting each microphone 140 with a respective test sample position 142. In some embodiments, the test sample positions 142 denote locations on the test sample face 144 where test samples, e.g., samples of acoustic covers, can be affixed to each fully cover the ports 138. In other embodiments, the test sample positions 142 can designate surface features (not shown) which can further enable test samples to be affixed to the test sample face 144.

FIG. 2 shows the high throughput acoustic test apparatus 100 of FIG. 1 in a closed position 100b. In the fully closed position 100b, the second element 130 is fully connected with the first element 102, with the first and second alignment features 120, 150 being fully engaged. The test sample face 144 is flush with the substrate 104 of the first element 102. The acoustic cavity 106 is fully enclosed between the void 110, the acoustic source 114, and the test sample face 144 of the sample holder 136.

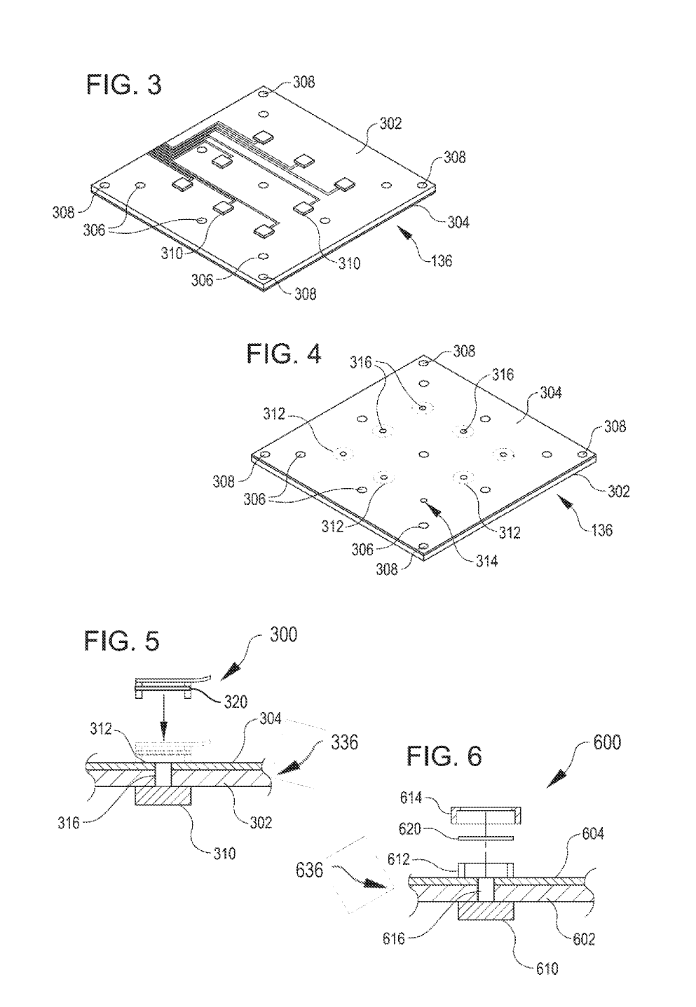

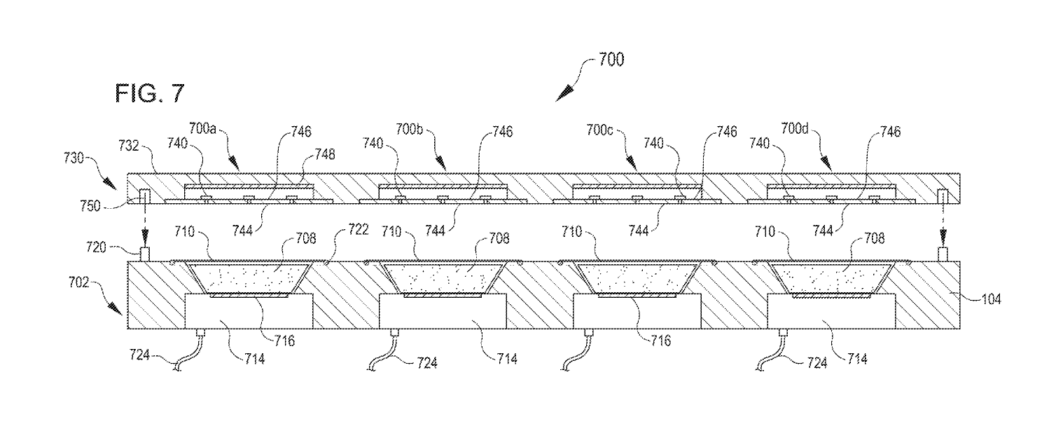

FIG. 3 shows an example of a first sample holder 136, as shown in the assembly 100 of FIGS. 1 and 2, in a perspective view and showing the microphone side 146 of the sample holder 136. The sample holder 136 includes a backing layer 302 that supports a plurality of microphones 310, and a sample receiving layer 304 on the side of the backing layer opposite the microphones. According to some embodiments, the sample receiving layer 304 is a smooth polymer or coated layer that can receive and fully release test samples of acoustic vent structures. For example, and as described above, the sample receiving layer 304 can include a polyimide or polyimide coating that readily accepts and fully seals to adhesive test samples, and also permits test samples to fully release from the receiving layer when peeled away. The sample holder 306 can include a plurality of connectors 306 for holding the backing and sample receiving layers 302, 304 together; and can include connecting features 308 for attaching the sample holder with a testing assembly such as the assemblies 100, 700 of FIG. 1 or 7 (below). The connecting features 308 can include any suitable connector, such as a bolt, screw, pin, magnetic connector, snap-fit connector, or similar.

FIG. 4 shows the first sample holder 136 of FIG. 3 in a perspective view showing a test sample side 144 of the example holder. A plurality of acoustic ports 316 is visible, each acoustic port connecting through the sample holder 136 to connect with a respective one of the microphones 310. Each acoustic port 316 is associated with a respective test sample position 312. Where the sample receiving layer 304 is a smooth, coated layer for directly receiving adhesive test samples, the test sample positions 312 can comprise regions of the sample receiving layer surrounding each acoustic port 316, which may or may not be labeled for receiving a test sample. Preferably, at least one acoustic port is a reference port 314, which is structurally identical to a test port but which does not receive an acoustic test sample. The reference port 314 is used to obtain acoustic data in an “open” configuration during an acoustic sample test for, e.g., noise cancelling, source stability correction, and/or obtaining a phase shift associated with the unimpeded reference port for comparison to a phase shift associated with an acoustic port impeded by an acoustic test sample. In alternative embodiments, the sample receiving layer 304 further includes surface features (not shown) for receiving test samples. The reference port 314 also may be used to characterize changes in additional acoustic quality metrics including but not limited to: Total Harmonic Distortion, Signal to Noise Ratio, Rub and Buzz.

FIG. 5 shows an example of an acoustic cover test sample 300 including a test membrane 320 being positioned on a sample receiving layer 304 of an example sample holder 336 similar to the example holder 136 of FIGS. 3 and 4, in accordance with some embodiments. The acoustic cover test sample 300 shown is positioned at a sample position 312 and bridges over an acoustic test port 316, so that the test sample membrane 320 closes the test port.

In another aspect there is provided an acoustic cover test sample 600 including a test membrane 620 positioned on a sample holder 636, as shown in FIG. 6. The sample holder 636 includes a backing layer 602 and a sample receiving layer 604, similar to the sample holder 136 described above with reference to FIGS. 3-5. An acoustic test port 616 is shown passing through the sample holder 600 and connecting with a measurement microphone 610 on the backing layer 602. Opposite the measurement microphone 610 and on the sample receiving layer 604, sample retaining features 612 are shown adjacent to the acoustic test port 616. The retaining features 612 can be any suitable surface features for retaining an acoustic vent structure, e.g., comprising at least one membrane. According to some embodiments, a retaining features can include, e.g., an adhesive element such as a double-sided tape, mechanical connectors, indentations, alignment markers, or the like. In the example shown, the retaining features 612 include an elevated ring for receiving a sample acoustic vent structure 620, and a cover 614 that can connect with the retaining features 612 over the structure to seal in place.

Parts of the apparatus described above can be repeated and positioned to increase the number of acoustic test samples that can be assessed simultaneously. In the embodiments of sample holders (e.g., sample holder 136 shown in FIGS. 1-4), described above, eight acoustic ports 116 are positioned on the sample holder and spaced approximately equidistantly. However, it will be understood that more or fewer acoustic ports could be positioned on a single sample holder without deviating from the teaching of this disclosure. In certain embodiments, the acoustic ports 116 are positioned within one wavelength of one another or less, based on the maximum test frequency of the apparatus.

To increase the throughput a test apparatus may have a plurality of acoustic cavities in the first element and a corresponding number of sample holders in the second element. The number of acoustic cavities may be from 2 to 10, e.g., from 3 or 8. In one exemplary embodiment, the four acoustic cavities may be employed as shown in FIG. 7. The high throughput acoustic test apparatus 700 has multiple acoustic chambers 700a-d. Each acoustic chamber 700a-d has a corresponding assembly similar to the test assembly 100 shown in FIG. 1. Analogous parts in FIG. 7 are numbered in similar fashion to the parts in FIG. 1, replacing the 100's place with 700 (i.e. acoustic sources 714 are analogous to acoustic source 114 of FIG. 1, sample holders 736 are analogous to sample holder 136, etc.). It may be useful to employ separate sound sources for each cavity, but it is within the scope of this disclosure to use one sound source for multiple cavities.

Apparatus 700 has multiple acoustic cavities 706 positioned within a single first element 702 and arranged to align with multiple sample holders 736 of a singular second element 730. The first element 702 also contains multiple acoustic sources 714, each acoustic source facing a respective sample holder 736 across a respective acoustic cavity 706. The alignment features 720 of the first element 702 are arranged to repeatably align the first and second elements 702, 730 together to align each respective acoustic cavity 706 with a respective sample holder 736. The test apparatus 700 shown illustrates an assembly having four acoustic cavities 706 and associated components; however it will be understood that a high throughput test apparatus can have more or can have fewer than four acoustic cavities.

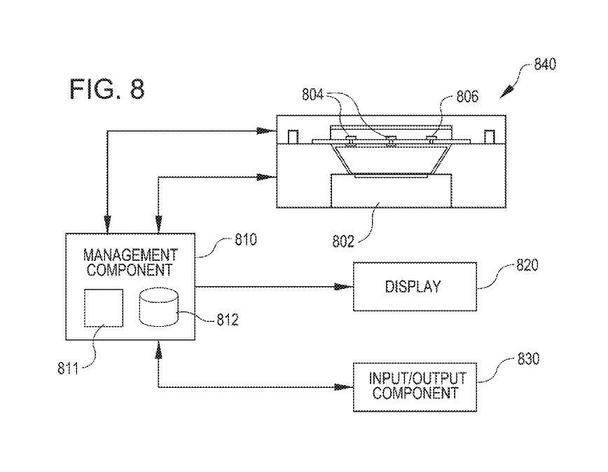

FIG. 8 shows an example system 800 for performing high throughput testing of acoustic vent structures using testing apparatus such as the apparatus of FIG. 1 or 7. The system 800 includes a high throughput testing apparatus 840, which can have similar features to the testing apparatuses 100 or 700 (FIGS. 1 and 7). The testing apparatus 840 includes at least an acoustic source 802, and a plurality of microphones including multiple measurement microphones 804 and at least one reference microphone 806. The system 800 further includes a management component 810 that includes a processor 811 and memory 812, a display component 820 for displaying information to a user, and an input/output component 830 that can receive instructions from a user. The memory 812 is non-transitory and contains instructions for operating the acoustic source 802 and for detecting an audio signal from the test and reference microphones 804, 806. The system 800 is capable of operating in an open condition and in a closed condition. In an open condition, the system 800 causes the acoustic source 802 to emit an acoustic signal while no test samples are present in the test apparatus 840. In a test condition, the system 800 causes the acoustic source 802 to emit the acoustic signal while the test apparatus 840 is loaded with acoustic test samples. An insertion loss for each test sample can be obtained by subtracting the acoustic signal obtained for each microphone in the test condition from an acoustic signal obtained for the same respective microphone in the open condition.

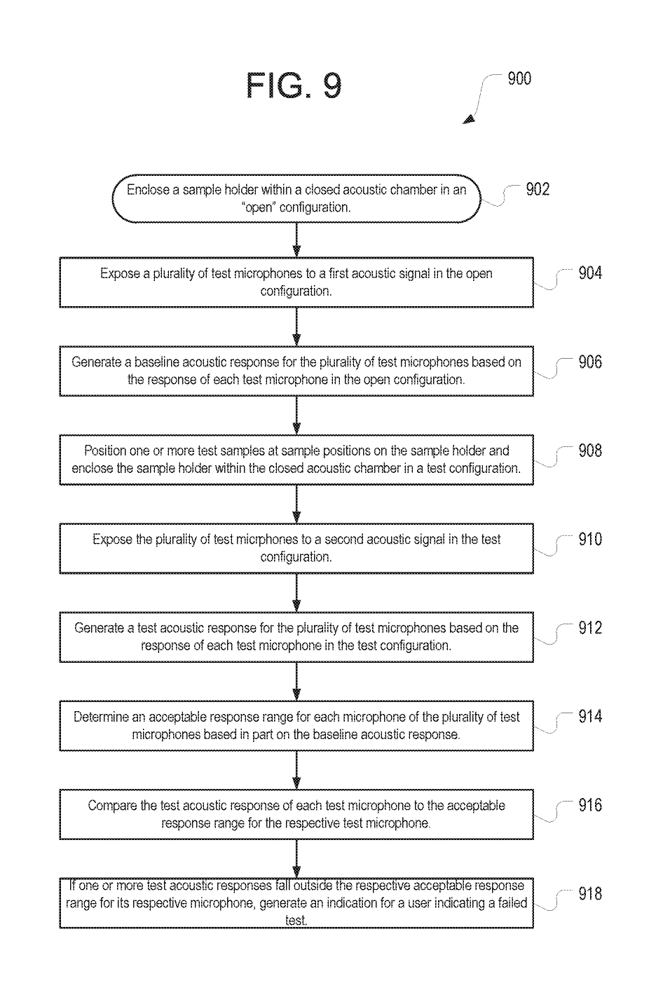

FIG. 9 illustrates an example process 900 for utilizing a testing apparatus such as apparatus 100 or 700 as shown in FIG. 1, 7 or 8. The example process 900 can be performed in conjunction with the system 800 shown in FIG. 8, in accordance with embodiments. First, a sample holder can be enclosed within an acoustic chamber of a test apparatus in an open configuration (act 902). A first acoustic signal can be generated by an acoustic source, exposing a plurality of measurement microphones and/or reference microphones to the acoustic signal in the open configuration (act 904). Then a baseline acoustic response can be generated from the test and/or reference microphones based on the acoustic response of each microphone to the acoustic signal (act 906).

Next, one or more test samples can be positioned at sample positions on the sample holder and enclosed within the closed acoustic chamber in a test configuration (act 908). The plurality of measurement microphones can be exposed to a second acoustic signal while covered by the test samples (act 910). From each acoustic stimulus measured, sound pressure level across the test frequency range of interest should not deviate by more than 6 dB. Then, a test acoustic response can be generated for the plurality of measurement microphones based on the response of each measurement microphone in the test configuration (act 912). An acceptable response range can be generated for each microphone based in part on the baseline acoustic response (act 914) and corrected by reference microphone. In one embodiment, consecutive testing can have a deviation of 1 dB or less, when correction is used, e.g., 0.5 dB or less or 0.3 dB or less.

Next, the test acoustic responses for each microphone can be compared to the baseline acoustic responses for each microphone in order to calculate an acoustic insertion loss for each respective test sample (act 916). If one or more acoustic insertion losses exceeds a predetermined threshold (i.e., if one or more test responses exceeds a suitable predetermined threshold for acoustic loss), the system can generate an indication for presentation to a user that the test has failed. Test method throughput is most preferably 3 parts per minute or greater. Where a reference microphone is provided, a reference signal obtained by the reference microphone can be used, e.g., for noise cancellation, source stability correction, and/or obtaining a phase shift associated with the unimpeded reference port. For example, a phase shift associated with the reference microphone can be detected and compared with a phase shift associated with a measurement microphone to determine a phase shift caused by each respective test sample.

### Example 1

In an example “open” test, an acoustic testing apparatus similar to the apparatus of FIG. 7 was configured with a testing system similar to the system 800 of FIG. 8, in an “open” condition, wherein the 28 available sample locations (and four reference ports) were left uncovered. The testing apparatus was closed to seal the acoustic chamber, and the system was operated through a frequency range of 100 Hz to 20 kHz at amplitude of 94 dB SPL (referenced to 20 μPa). The acoustic insertion loss across the acoustic cavity and respective ports in the sample holders was measured across the frequency range.

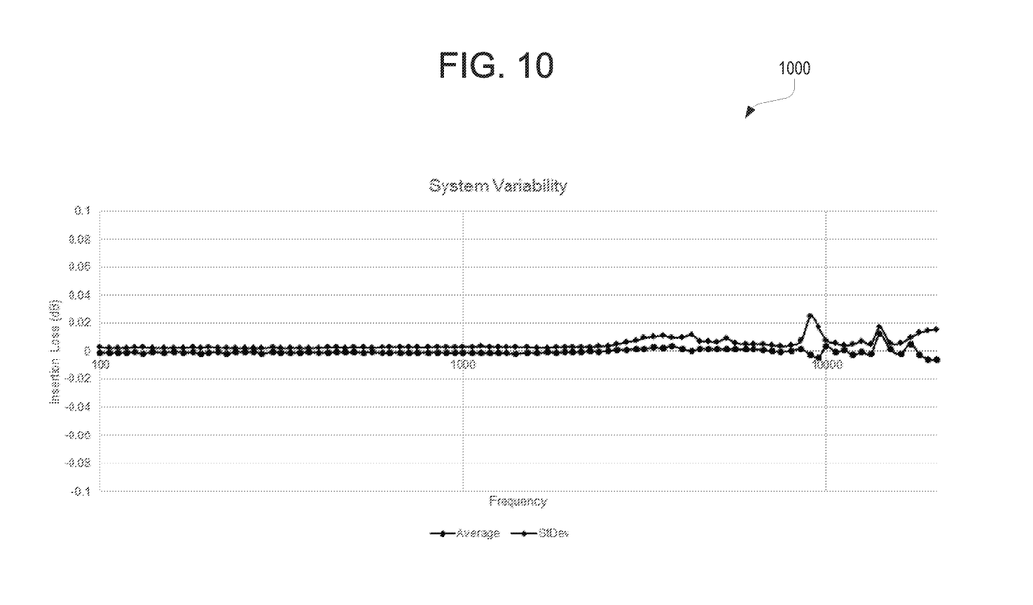

FIG. 10 shows a graphical representation illustrating the acoustic insertion loss variability between the acoustic ports in the testing apparatus described above. The average acoustic loss measured across the test sample and reference microphones was nearly zero as expected across the entire frequency range, with minor variability detected only at high frequencies (i.e. above 10 kHz). The data illustrate that the microphones consistently detected the sound pressure level across the entire apparatus for a wide range of frequencies.

In the preceding description, for the purposes of explanation, numerous details have been set forth in order to provide an understanding of various embodiments of the present invention. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present invention. Accordingly, the above description should not be taken as limiting the scope of the present invention or claims.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the present invention, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a filter” includes a plurality of such filters, and reference to “the support member” includes reference to one or more support members and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

What is claimed is:

1. A testing apparatus for measuring acoustic properties of acoustic vent structures, the apparatus comprising:
a first element and second element, the second element being removably connectible to the first element, wherein the first and second elements define at least one closed acoustic chamber when the first and second elements are connected, wherein:
the first element comprises at least one acoustic cavity, one or more first alignment features, and at least one sound source capable of generating sound within each of the at least one acoustic cavities;
the second element comprises one or more second alignment features arranged to connect with the one or more first alignment features, a plurality of microphones configured to detect acoustic signals, a plurality of ports that each define an acoustic channel between one of the at least one closed acoustic chamber and one of the plurality of microphones, and one or more sample holders for a plurality of acoustic vent structures to be positioned over at least one of the plurality of microphones; and
each of the at least one acoustic cavity are aligned with the plurality of ports when the second element is connected with the first element.

2. The apparatus of claim 1, wherein the sound source is capable of generating sound within each of the at least one acoustic cavities in the range of 10 Hz to 30 kHz.

3. The apparatus of claim 1, wherein the sound source is capable of generating sound within each of the at least one acoustic cavities in the range of 10 Hz to 20 kHz.

4. The apparatus of claim 1, wherein:
the plurality of sample holders comprises at least one plate containing the plurality of ports therethrough;
the plurality of microphones are positioned on a first side of the plate opposite the closed acoustic chamber; and
a second side of the plate facing the closed acoustic chamber is configured to receive the plurality of acoustic vent structures.

5. The apparatus of claim 4, wherein the at least one plate is removable from the second element.

6. The apparatus of claim 1, wherein each microphone of the plurality of microphones is a MEMS microphone.

7. The apparatus of claim 1, wherein:
the acoustic cavity is at least partially filled with a passive damping material.

8. The apparatus of claim 7, wherein the passive damping material is selected from a group comprising foamed synthetic resins, felts, non-woven fabrics, synthetic resin fibers and mineral fibers.

9. The apparatus of claim 7, wherein the passive damping material is fibrillated foam.

10. The apparatus of claim 1, wherein the second element can be repeatably aligned with the first element within a tolerance of 0.1 mm.

11. The apparatus of claim 1, further comprising a backing cavity arranged on a side of the sample holder opposite to the at least one closed acoustic cavity, wherein the backing cavity comprises an acoustic dampening material.

12. The apparatus of claim 1, wherein the one or more sample holders comprises one or more flat plates adapted for adhering to the plurality of acoustic vent structures.

13. The apparatus of claim 1, wherein the one or more sample holders comprises a plurality of surface features each configured to receive a acoustic vent structure of the plurality of acoustic vent structures.

14. The apparatus of claim 1 wherein the one or more first alignment features comprise posts.

15. The apparatus of claim 1 wherein the one or more second alignment feature comprise holes.

16. The apparatus of claim 1 wherein a distance between the one or more sample holders and the at least one sound source is less than one wavelength of a highest measured frequency when the first and second elements are connected.

17. The apparatus of claim 1, wherein the at least one closed acoustic chamber comprises at least four closed acoustic chambers.

18. The apparatus of claim 1, wherein the one or more sample holders each comprise a polyimide coating facing the closed acoustic chamber.

19. The apparatus of claim 1, wherein the ports of the plurality of ports comprise one or more sets of ports each corresponding to a closed acoustic chamber of the at least one closed acoustic chamber, and wherein the ports of each set are arranged spaced less than one wavelength from one another, the one wavelength corresponding to a highest measured frequency.

20. The apparatus of claim 1, wherein each void of the plurality of ports is 1 mm in diameter or less.

21. The apparatus of claim 1, wherein the second element further comprises at least one reference microphone, the at least one reference microphone being connected with at least one reference port of the plurality of ports and being separated from the closed acoustic chamber by the one or more sample holders.

22. A method of quantifying an acoustic parameter of a plurality of test samples, the method comprising:
utilizing a testing apparatus comprising a first element and a second element, the second element being removably connectible to the first element, wherein
the first and second elements define at least one closed acoustic chamber when the first and second elements are connected;
the first element comprising at least one acoustic cavity and at least one sound source capable of generating sound within each of the at least one acoustic cavity; and
the second element comprises a plurality of measurement microphones configured to detect acoustic signals, a plurality of ports that each define an acoustic channel between one of the at least one closed acoustic chamber and one of the plurality of measurement microphones, and one or more sample holders for each test sample of the plurality of test samples to be positioned over a respective one of the plurality of measurement microphones;
positioning each test sample of the plurality of test samples at sample positions on the one or more sample holders, each test sample covering a respective port of the plurality of ports and enclosed within the closed acoustic chamber;
exposing the plurality of measurement microphones to an acoustic signal via the at least one sound source while the ports are covered by the test samples;
generating a test acoustic response for each measurement microphone of the plurality of measurement microphones based on a response of each measurement microphone to the acoustic signal;
quantifying the acoustic parameter for each test sample of the plurality of test samples based in part on the test acoustic response for each respective measurement microphone.

23. The method of claim 22, wherein:
the test acoustic response for each measurement microphone comprises a test acoustic pressure;
the acoustic parameter comprises an acoustic insertion loss; and
quantifying the acoustic parameter for each test sample comprises comparing the test acoustic pressure to a predetermined baseline acoustic pressure.

24. The method of claim 22, wherein:
the second element further comprises a reference microphone, the reference microphone being connected with a reference port of the plurality of ports and being connected with the closed acoustic chamber by the reference port with no intervening test sample;
the test acoustic response for each measurement microphone comprises a test acoustic phase;
the acoustic parameter comprises a phase shift; and
quantifying the acoustic parameter for each test sample comprises:
generating a reference acoustic response for the reference microphone; and
quantifying the phase shift for each test sample of the plurality of test samples by comparing the test acoustic phase for each respective measurement microphone with the reference acoustic response.

25. The method of claim 22, wherein exposing the plurality of measurement microphones to the acoustic signal comprises exposing the plurality of measurement microphones to a series of frequencies ranging from 10 Hz to 30 kHz.

26. The method of claim 22, wherein:
the second element further comprises a reference microphone, the reference microphone being connected with a reference port of the plurality of ports and being connected with the closed acoustic chamber by the reference port with no intervening test sample;
the test acoustic response for each measurement microphone comprises a test acoustic parameter comprising one of a test total distortion, test total harmonic distortion, a test intermodulated distortion, a test difference frequency distortion, a test total harmonic distortion plus noise, a test acoustic rub, a test acoustic buzz, or a test acoustic signal to noise ratio; and
quantifying the acoustic parameter for each test sample comprises:
generating a reference acoustic response for the reference microphone; and
quantifying the acoustic parameter for each test sample of the plurality of test samples by comparing the test acoustic response for each respective measurement microphone with the reference acoustic response.

27. The method of claim 22, wherein the acoustic parameter comprises one of a total distortion, total harmonic distortion, intermodulated distortion, difference frequency distortion, total harmonic distortion plus noise, acoustic rub, acoustic buzz, perceptual acoustic rub, perceptual acoustic buzz, or signal to noise ratio.
